(19) United States
(12) Patent Application Publication
(10) Pub. No.: US 2024/0345288 A1
(43) Pub. Date: Oct. 17, 2024

(54) METHOD FOR CONVERTING TROPICAL CYCLONE INTENSITY AT DIFFERENT TIME INTERVALS AND SYSTEM THEREOF

(71) Applicants: Shanghai Typhoon Institute of the China Meteorological Administration, Shanghai (CN); Asia-Pacific Typhoon Collaborative Research center, Shanghai (CN)

(72) Inventors: Lina Bai, Shanghai (CN); Jie Tang, Shanghai (CN); Rong Guo, Shanghai (CN); Rijin Wan, Shanghai (CN)

(21) Appl. No.: 18/433,491

(22) Filed: Feb. 6, 2024

(30) Foreign Application Priority Data
Apr. 14, 2023 (CN) 2023103994272

(51) Int. Cl. G01W 1/06

(52) U.S. Cl. CPC G01W 1/06

(57) ABSTRACT

A method and a system for converting tropical cyclone intensity at different time intervals are provided. The method includes the following steps: obtaining intensity data and path information of the tropical cyclone to be determined; determining an average time interval of the tropical cyclone to be determined under average wind speed based on the intensity data; using the path information to determine the type of tropical cyclone to be determined; if the tropical cyclone to be determined is a tropical cyclone over ocean, determining the current intensity index corresponding to the tropical cyclone over ocean at a specific time interval; obtaining the average maximum wind speed of the tropical cyclone over ocean at a specific time interval based on the current intensity index. It realizes the tropical cyclone intensity conversion at different time intervals, providing a basis for determining and predicting tropical cyclone intensity.

### CROSS-REFERENCE

This application claims to the benefit of priority from Chinese Application No. 202310399427.2 with a filing date of Apr. 14, 2023. The content of the aforementioned applications, including any intervening amendments thereto, are incorporated herein by reference.

### TECHNICAL FIELD

The present disclosure relates to the field of tropical cyclone intensity determination technology, specifically to a method for converting tropical cyclone intensity at different time intervals and a system thereof.

### BACKGROUND

The disasters caused by tropical cyclones are closely related to their intensity. Thus, the accuracy of tropical cyclone intensity determination methods directly affects the accuracy of tropical cyclone intensity, prediction and warning of wind, rain, and disaster. Currently, existing standards use the maximum average wind speed near the center of a tropical cyclone to characterize tropical cyclone intensity. The tropical cyclone intensity at different time intervals is not entirely linear. If linear coefficients are used for conversion, there will be significant errors between the converted and actual values of the average maximum wind speed at different time intervals (Bai et al., 2023). Moreover, when a tropical cyclone is located at sea or on land, the corresponding determination methods are completely different, so using the same conversion coefficient is obviously not accurate enough. Therefore, it is necessary to perform the tropical cyclone intensity conversion at different time intervals in different regions.

At present, the average time interval of the maximum wind speed used by meteorological agencies in various countries varies. The Joint Typhoon Warning Center in United States uses a 1-minute average wind speed, the Japan Regional Professional Meteorological Center and the Hong Kong Observatory use a 10-minute average wind speed, and the China Meteorological Administration uses a 2-minute average wind speed. As a result, there is a significant difference in the intensity of the same tropical cyclone between different data at the same time. Due to the current limited linear conversion coefficients for 1-minute and 10-minute average wind speeds (WMO, 2012) and the lack of other conversion relationships for tropical cyclone intensity at different time intervals, research and practical application of tropical cyclone intensity have been challenging.

### SUMMARY

In response to the deficiency of existing methods and the shortcomings of practical applications, the present disclosure provides a conversion method for the tropical cyclone intensity at different time intervals based on the location of the tropical cyclone center in the ocean or on land, so as to improve the accuracy and applicability of the conversion results. The first aspect of the present disclosure provides a method for converting tropical cyclone intensity at different time intervals, including the following steps: obtaining intensity data and path information of the tropical cyclone to be determined; determining the average time interval of the tropical cyclone to be determined under average wind speed based on its intensity data; using the path information to determine the type of tropical cyclone to be determined; if the tropical cyclone to be determined is a tropical cyclone over ocean, then determining the current intensity index corresponding to the tropical cyclone over ocean at a specific time interval; based on the current intensity index, obtaining the average maximum wind speed of the tropical cyclone over ocean at the specific time interval. The present disclosure provides for the first time a method for converting tropical cyclone intensity between different time intervals, and classifies tropical cyclones in different regions, making the conversion coefficient more accurate and the intensity conversion results more accurate.

Optionally, the method for converting tropical cyclone intensity at different time intervals includes: if the tropical cyclone to be determined is a tropical cyclone over land, determining a conversion coefficient of the tropical cyclone over land; determining a conversion index corresponding to the tropical cyclone over land at a specific time interval based on the average time interval, the conversion coefficient, and the intensity data; obtaining an average maximum wind speed of the tropical cyclone over land at the specific time interval through the conversion index. The present disclosure adopts different intensity conversion methods for the tropical cyclone over land, further improving the accuracy of tropical cyclone intensity conversion results and the practicality of conversion methods.

Optionally, the step of using the path information to determine a type of the tropical cyclone to be determined includes the following steps: determining a center position of the tropical cyclone based on the path information of the tropical cyclone to be determined; if the center position is on ocean, then the tropical cyclone to be determined is a tropical cyclone over ocean; if the center position is on land, then the tropical cyclone to be determined is a tropical cyclone over land. The present disclosure classifies the types of tropical cyclones and matches corresponding tropical cyclone intensity conversion coefficients according to the types, thereby improving the accuracy and practicality of the tropical cyclone intensity conversion coefficient method.

Optionally, the method for converting tropical cyclone intensity at different time intervals further includes: introducing a benchmark value, and the benchmark value is the current intensity index of the tropical cyclone. The present disclosure standardizes the intensity conversion method and improves the accuracy of intensity conversion results by introducing the current intensity index as the benchmark value for tropical cyclone intensity conversion methods.

Optionally, the method for converting tropical cyclone intensity at different time intervals further includes: setting a specific time interval, wherein the specific time interval is set between 1 and 10 minutes for converting the current intensity index between different average time intervals.

Optionally, the step of determining the current intensity index corresponding to the tropical cyclone over ocean at the specific time interval includes the following steps: according to a conversion coefficient table between the current intensity index of the tropical cyclone to be determined and the tropical cyclone intensity at different time intervals; determining the current intensity index corresponding to the tropical cyclone over ocean at a specific time interval. The present disclosure uses a conversion coefficient table to determine the current intensity index, making the process of obtaining various values simpler, faster, and more convenient, improving the efficiency of tropical cyclone intensity conversion, and having high practicality in the field of tropical cyclones.

Optionally, the step of determining a current intensity index corresponding to the tropical cyclone over ocean at a specific time interval includes the following steps: performing linearly interpolating on the average wind speed and the current intensity index separately based on the current intensity index of the tropical cyclone to be determined; determining the current intensity index corresponding to the tropical cyclone over ocean at the specific time interval. The current intensity index calculation method is as follows:

$$CI = \frac{{CI}_{2} - {CI}_{1}}{{V}_{2} - {V}_{1}} \times ( V - {V}_{1} ) + {CI}_{1}$$

Wherein, CI denotes the current intensity index corresponding to the tropical cyclone to be determined at the specific time interval, CI₂ denotes the current intensity index corresponding to V₂, CI₁ denotes the current intensity index corresponding to V₁, V₂ denotes the average wind speed value greater than and closest to the tropical cyclone to be determined, V₁ denotes the average wind speed value less than and closest to the tropical cyclone to be determined, and V denotes the average wind speed value of the tropical cyclone to be determined. The present disclosure obtains the current intensity index through formula calculation, which can accurately and quickly obtain relevant data, save time, and improve the accuracy of the results.

Optionally, the step of obtaining average maximum wind speed of the tropical cyclone over ocean at the specific time interval based on the current intensity index, the average maximum wind speed at the specific time interval is calculated by the following formula:

$${V}_{specific time interval} = \frac{{V}_{22} - {V}_{11}}{{CI}_{2} - {CI}_{1}} \times ( CI - {CI}_{1} ) + {V}_{11}$$

Wherein, V_{specific time interval} denotes the average maximum wind speed at the specific time interval, V₂₂ denotes the corresponding average wind speed value of CI₂ at a specific time interval, V₁₁ denotes the corresponding average wind speed value of CI₁ at a specific time interval, CI₂ denotes the current intensity index corresponding to V₂, CI₁ denotes the current intensity index corresponding to V₁, and CI denotes the current intensity index of the tropical cyclone over ocean at a specific time interval.

Optionally, the step of determining a conversion index corresponding to the tropical cyclone over land at a specific time interval includes the following steps: determining the closest distance between the center of the tropical cyclone over land and the coastline; matching the conversion coefficient of observed wind speed between different time intervals based on the closest distance; determining the conversion index corresponding to the tropical cyclone over land at a specific time interval through the conversion coefficient. The present disclosure adopts the closest distance between the center position of a tropical cyclone and the coastline as the distinguishing method for the conversion coefficient of the tropical cyclone over land. This distinguishing method is simple and convenient, and is conducive to implementation, making the effect of tropical cyclone intensity conversion more accurate, thereby improving the superiority of China tropical cyclone intensity data compared to other international tropical cyclone intensity data.

The second aspect, in order to efficiently execute the method for converting tropical cyclone intensity at different time intervals provided by the present disclosure, the present disclosure also provides a system for converting tropical cyclone intensity at different time intervals, including a processor, an input device, an output device, and a memory. The processor, the input device, the output device, and the memory are interconnected, wherein the memory is used to store computer programs, the computer program includes program instructions, and the processor is configured to invoke the program instructions to execute the method for converting tropical cyclone intensity at different time intervals as described in the first aspect of the present disclosure. The present disclosure relates to the system for converting tropical cyclone intensity at different time intervals, which has a compact structure and stable performance, and can stably execute the method for converting tropical cyclone intensity at different time intervals provided by the present disclosure, improving the overall applicability and practical application ability of the present disclosure.

### BRIEF DESCRIPTION OF THE DRAWINGS

FIG. 1 is a flowchart of the method for converting tropical cyclone intensity at different time intervals of the present disclosure;

FIG. 2 is a structural diagram of the system for converting tropical cyclone intensity at different time intervals of the present disclosure.

### DETAILED DESCRIPTION OF THE EMBODIMENTS

The specific embodiments of the present disclosure will be described in detail below. It should be noted that the embodiments described here are only for illustrative purposes and are not intended to limit the present disclosure. In the following description, a large number of specific details are elaborated to provide a thorough understanding of the present disclosure. However, it is obvious to ordinary skilled person in the art that it is not necessary to use these specific details to implement the present disclosure. In other embodiments, in order to avoid confusion with the present disclosure, there is no specific description of well-known circuits, software, or methods.

Throughout the entire specification, references to “one embodiment”, “embodiment”, “one example”, or “example” imply that specific features, structures, or features described in conjunction with the embodiment or example are included in at least one embodiment of the present disclosure. Therefore, the phrases “in one embodiment”, “in an embodiment”, “an example”, or “example” that appear throughout the entire specification may not necessarily refer to the same embodiment or example. In addition, specific features, structures, or characteristics can be combined in one or more embodiments or examples in any appropriate combination and/or sub combination. In addition, ordinary skilled person in the art should understand that the illustrations provided here are for illustrative purposes and may not necessarily be drawn to scale.

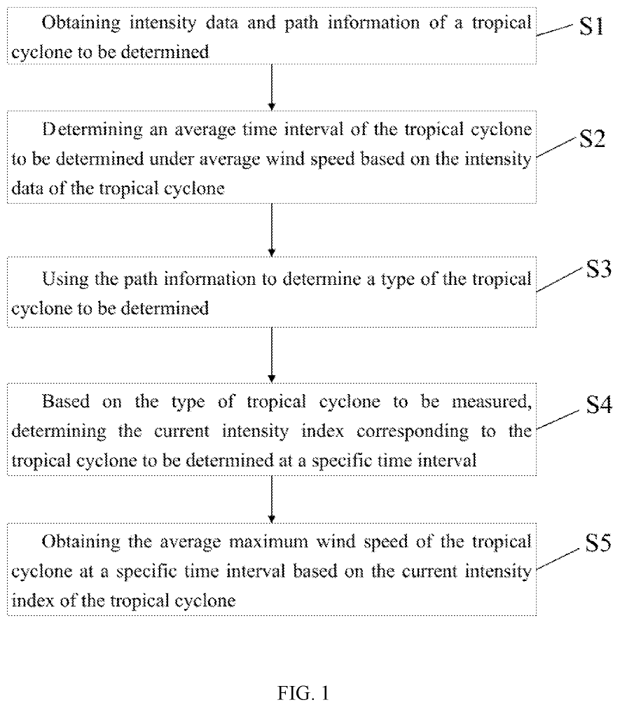

Please refer to FIG. 1, in order to achieve mutual conversion of tropical cyclone intensity at different time intervals, improve the accuracy of intensity conversion results, provide a basis for determining and predicting tropical cyclone intensity, and enhance the overall applicability and practical application ability of the present disclosure, the present disclosure provides a method for converting tropical cyclone intensity at different time intervals, including the following steps:

S1, Obtaining intensity data and path information of a tropical cyclone to be determined.

In this embodiment, meteorological agencies in various countries will release typhoon intensity information and typhoon center location information. Therefore, the current typhoon intensity information and the current typhoon center location information can be retrieved from the typhoon operational center through data calling.

The obtained methods listed in the above embodiments are only the preferred conditions of the present disclosure. In other embodiments, the methods for obtaining the intensity data and the path information of the tropical cyclone to be determined can be flexibly selected according to practical needs.

S2, Determining an average time interval of the tropical cyclone to be determined under average wind speed based on the intensity data of the tropical cyclone.

In this embodiment, information on the average time interval of the tropical cyclone can be obtained based on the explanatory document of the tropical cyclone intensity data or the source of the intensity data. Based on the information on the average time interval, the average time interval of the tropical cyclone under average wind speed can be further determined.

Furthermore, the average time interval in this embodiment refers to the time interval at which wind speeds are recorded for determining the maximum average wind speed of a tropical cyclone. The shorter the prescribed time interval, the greater the maximum average wind speed obtained, which means the greater the basic wind pressure. The average time interval standards currently used by countries around the world are not consistent. For example, the United States Joint Typhoon Warning Center uses a 1-minute average wind speed, the Japan Regional Meteorological Center and the Hong Kong Observatory use a 10-minute average wind speed, and the China Meteorological Administration uses a 2-minute average wind speed. Therefore, the standards for basic wind pressure values vary among countries.

S3, Using the path information to determine a type of the tropical cyclone to be determined.

The specific step of using the path information of the tropical cyclone to determine a type of the tropical cyclone are shown as below:

First, determining a center position of the tropical cyclone based on the path information of the tropical cyclone to be determined.

Then, based on the central position, further determining the type of tropical cyclone, which belongs to a tropical cyclone over ocean or a tropical cyclone over land.

If the center position is on ocean, then the tropical cyclone to be determined is a tropical cyclone over ocean; if the center position is on land, then the tropical cyclone to be determined is a tropical cyclone over land, so that the specific type of tropical cyclone can be quickly and accurately determined.

In this embodiment, based on whether the center of the tropical cyclone to be determined is located on the ocean or on land, a conversion method between tropical cyclone intensity with different time intervals is provided to improve the accuracy of tropical cyclone intensity conversion results and provide a basis for determining and predicting tropical cyclone intensity.

Furthermore, in this embodiment, tropical cyclones are divided into two types based on their central position: tropical cyclone over oceans and tropical cyclone over lands, in order to fully implement the present disclosure. Other embodiments may also be implemented in a different way than described herein.

S4, Based on the type of tropical cyclone to be measured, determining the current intensity index corresponding to the tropical cyclone to be determined at a specific time interval.

In one embodiment, if the tropical cyclone to be determined is a tropical cyclone over ocean, further determining the current intensity index corresponding to the tropical cyclone over ocean at an average time interval of 2 minutes. The 2-minute average time interval described in this embodiment is only a preferred embodiment of the present disclosure, and specific time intervals may be modified according to practical needs in one or more other embodiments.

In this embodiment, if the tropical cyclone over ocean has a 2-minute average wind speed, based on the intensity data of the tropical cyclone over ocean, the conversion coefficient table between the current intensity index and the tropical cyclone intensity at different time intervals is used to directly obtain the corresponding current intensity index of the tropical cyclone over ocean at a 2-minute time interval.

In this embodiment, the conversion coefficient table between the current intensity index and the tropical cyclone intensity at different time intervals is used to directly determine the current intensity index corresponding to the tropical cyclone over ocean at a 2-minute average time interval based on the correspondence of the current intensity index-maximum wind speed in the table.

Furthermore, in this embodiment, in order to obtain the current intensity index of the tropical cyclone, a benchmark value and a conversion coefficient table are introduced. In this embodiment, the benchmark value refers to the current intensity index of the tropical cyclone, and operational service centers worldwide use the 1984 version of Dvorak technology to estimate the intensity of the tropical cyclone. The specific process of the Dvorak technology mentioned above is to determine the current intensity index of a tropical cyclone based on the cloud pattern of tropical cyclones on satellite cloud images. The current intensity index varies from 1 to 8, with a variation unit of 0.5; Then, based on the empirical conversion relationship between the current intensity index and the maximum wind speed near the center of the tropical cyclone, the intensity of the tropical cyclone is finally obtained.

In this embodiment, the conversion coefficient table between the current intensity index and the tropical cyclone intensity at different time intervals is shown in Table 1:

TABLE 1
Conversion coefficient between current intensity index and
tropical cyclone intensity at different time intervals

| Current | | | |
|---|---|---|---|
| intensity | Maximum wind speed (m/s) | | |
| index | 1-minute average | 2-minute average | 10-minute average |
| 1.5 | 13 | 13 | 15 |
| 2.0 | 15 | 15 | 19 |
| 2.5 | 18 | 18 | 22 |
| 3.0 | 23 | 23 | 26 |
| 3.5 | 28 | 28 | 29 |
| 4.0 | 33 | 33 | 33 |
| 4.5 | 40 | 38 | 37 |
| 5.0 | 46 | 42 | 40 |
| 5.5 | 52 | 48 | 44 |
| 6.0 | 59 | 52 | 48 |
| 6.5 | 65 | 58 | 51 |
| 7.0 | 72 | 62 | 55 |
| 7.5 | 80 | 68 | 59 |
| 8.0 | 87 | 75 | 63 |

Based on this, in this embodiment, if the tropical cyclone over ocean has a 1-minute average wind speed, according to the intensity data of the tropical cyclone over ocean, the corresponding current intensity index at a 2-minute time interval is obtained. The specific implementation steps are as follows:

Firstly, determine whether the 1-minute average wind speed of the tropical cyclone over ocean exactly matches the values of the conversion coefficient between the 1-minute average maximum wind speed and the current intensity index in Table 1.

If the 1-minute average wind speed of the tropical cyclone over ocean exactly matches the values in Table 1;

Then, according to the conversion coefficient between the 1-minute average maximum wind speed and the current intensity index in Table 1, the corresponding current intensity index corresponding to the tropical cyclone over ocean at the 2-minute time interval can be directly obtained.

Furthermore, in this embodiment, the average time interval of the tropical cyclone over ocean is set to 1 minute for the full implementation of the present disclosure, and other setting conditions different from this time interval can be used in other embodiments.

Based on this, if the 1-minute average wind speed of the tropical cyclone over ocean to be determined does not meet the values in Table 1, the specific implementation steps are as follows:

Firstly, based on the conversion coefficient between the 1-minute average maximum wind speed and the current intensity index in Table 1, linear interpolation is performed on the 1-minute average wind speed and the current intensity index of the tropical cyclone over ocean separately. Furthermore, in this embodiment, the 1-minute average wind speed of the tropical cyclone over ocean is 56 m/s. Linear interpolation is performed on the 1-minute average wind speed and the current intensity index of the tropical cyclone over ocean separately. The specific implementation content is as follows:

According to the conversion coefficient between the 1-minute average maximum wind speed and the current intensity index in Table 1, it can be found that the 1-minute average wind speed of the tropical cyclone over ocean is 56 m/s, with wind speeds between 52 m/s (corresponding to the current intensity index of 5.5) and 59 m/s (corresponding to the current intensity index of 6.0). Linear interpolation is performed between 52 m/s and 59 m/s to obtain the corresponding current intensity index at a 2-minute time interval.

The specific calculation process for the linear interpolation of the 1-minute average wind speed of 56 m/s mentioned above is as follows:

$$5.79 = ( \frac{6.0 - 5.5}{59 - 52} ) \times ( 56 - 52 ) + 5.5$$

Furthermore, the specific condition of a 1-minute average wind speed of 56 m/s for the tropical cyclone over ocean described in this embodiment is convenient for the full implementation of the present disclosure, and can be modified and adjusted according to practical needs in other embodiments.

In another embodiment, if the tropical cyclone to be determined is a tropical cyclone over land, determining the conversion coefficient corresponding to the tropical cyclone over land at a 2-minute average time interval. Based on this, the 2-minute average time interval described in this embodiment is only a preferred embodiment of the present disclosure, and specific time intervals may be modified according to practical needs in one or more other embodiments.

In this embodiment, based on the average time interval and the intensity data of the tropical cyclone over land, and the conversion coefficient of observed wind speed between different average time intervals, the corresponding conversion coefficient of the tropical cyclone over land at a 2-minute average time interval is obtained.

In this embodiment, based on the distance between its center and the nearest coastline and the conversion coefficient table of observed wind speed between different average time intervals, the conversion coefficient of the tropical cyclone over land is obtained. The closest distance between the center of the tropical cyclone over land and the coastline is calculated as the reference object of the conversion coefficient, and other different reference conditions can be used in other embodiments.

Furthermore, in this embodiment, the closest distance between its center and the coastline is taken as the reference condition. If the closest distance is greater than 20 km, a conversion coefficient of the “inland” type is used; If the nearest distance is less than 20 km, a conversion factor of “onshore wind” type will be used. The specific setting of distance length can be adjusted according to practical needs to ensure the accuracy and authenticity of the conversion coefficient.

Furthermore, the conversion coefficients for observed wind speeds between different average time intervals recommended by the World Meteorological Organization are used in this embodiment, as shown in Table 2:

TABLE 2
Conversion coefficients of observed wind speeds between different average
time intervals recommended by the World Meteorological Organization

| | | | | Conversion coefficient | | |
|---|---|---|---|---|---|---|
| | | Average time | | Converted average time interval | | |
| Classification | Description | interval | | 1 minute | 2 minutes | 10 minutes |
| inland | Rough | 1 | minute | 1.00 | — | — |
| | ground | 2 | minutes | 1.13 | 1.00 | — |
| | surface | 10 | minutes | 1.21 | 1.12 | 1.00 |
| offshore | Offshore | 1 | minute | 1.00 | — | — |
| wind | winds in | 2 | minutes | 1.03 | 1.00 | — |
| | coastal areas | 10 | minutes | 1.16 | 1.09 | — |
| onshore wind | Coastal wind | 1 | minute | 1.00 | — | — |
| | in coastal | 2 | minutes | 1.03 | 1.00 | — |
| | areas | 10 | minutes | 1.11 | 1.05 | — |

S5. Obtaining the average maximum wind speed of the tropical cyclone at a specific time interval based on the current intensity index of the tropical cyclone.

In one embodiment, if the tropical cyclone to be determined is a tropical cyclone over ocean, obtaining the average maximum wind speed of the tropical cyclone at a specific time interval. The specific implementation steps are as follows:

In this embodiment, the current intensity index of the tropical cyclone over ocean is first used. If the tropical cyclone over ocean has a 2-minute average wind speed, based on Table 1, the conversion coefficient table between the current intensity index and the tropical cyclone intensity at different time intervals is used to directly obtain the average maximum wind speed of the tropical cyclone at a specific time interval.

Based on this, in this embodiment, if the tropical cyclone over ocean has a 1-minute average wind speed. Based on the current intensity index of the tropical cyclone over ocean to be determined, determining the average maximum wind speed of the tropical cyclone at a specific time interval. The specific implementation steps are as follows:

Determining whether the intensity index of the tropical cyclone over ocean with 1-minute average wind speed exactly matches the values of the conversion coefficient between the current intensity index and the tropical cyclone intensity at different time intervals in Table 1.

In this embodiment, if the 1-minute average wind speed tropical cyclone over ocean intensity index exactly matches the values in Table 1 for the conversion coefficient between the current intensity index and the intensity of tropical cyclones at different time intervals, the specific implementation steps are as follows:

Then, based on the conversion coefficient of the current intensity index to the 2-minute average wind speed in Table 1, the 2-minute average maximum wind speed of the tropical cyclone over ocean is determined.

In this embodiment, if the 1-minute average wind speed of the tropical cyclone over ocean intensity index does not match the values in Table 1 for the conversion coefficient between the current intensity index and the tropical cyclone intensity at different time intervals. The specific implementation steps are as follows:

According to the current intensity index corresponding to the 1-minute average wind speed value of 56 m/s in step S4;

In this embodiment, linear interpolation is performed using the values of the 2-minute average wind speed and the current intensity index in Table 1 to obtain the corresponding 2-minute average maximum wind speed. Furthermore, in this embodiment, the current intensity index corresponding to the 2-minute time interval of the tropical cyclone over ocean is 5.79. Based on the 2-minute average wind speed and the current intensity index in Table 1, the current intensity index is 5.5 (corresponding to a 2-minute average wind speed of 48 m/s) and 6.0 (corresponding to a 2-minute average wind speed of 52 m/s), and linear interpolation is performed between them, so as to determine the maximum wind speed corresponding to the 2-minute average time interval of the tropical cyclone over ocean.

The current intensity index of the above-mentioned tropical cyclone over ocean at a 2-minute time interval is 5.79, and then the maximum wind speed corresponding to its 2-minute average time interval is determined. The specific calculation process of the maximum wind speed mentioned above is as follows:

$$50.3 m / s = ( \frac{52 - 48}{6.0 - 5.5} ) \times ( 5.79 - 5.5 ) + 48$$

In another embodiment, if the tropical cyclone to be determined is a tropical cyclone over land, then determining the average maximum wind speed corresponding to the tropical cyclone over land at a specific time interval. The specific implementation steps are as follows:

In this embodiment, the conversion index corresponding to the tropical cyclone over land at a specific time interval is determined based on the average time interval, the conversion coefficient, and the intensity data corresponding to the tropical cyclone over land;

Through the conversion index, the average maximum wind speed of the tropical cyclone over land at a specific time interval is obtained.

In this embodiment, it is based on the conversion coefficients recommended by the World Meteorological Organisation (WMO) in Table 2 for conversion of observed wind speeds between different average time intervals for exponential conversion of a tropical cyclone over land in this embodiment, and the specific setting of the conversion coefficients in other embodiments may be adjusted according to the practical needs, so as to ensure the accuracy and authenticity of the conversion coefficients.

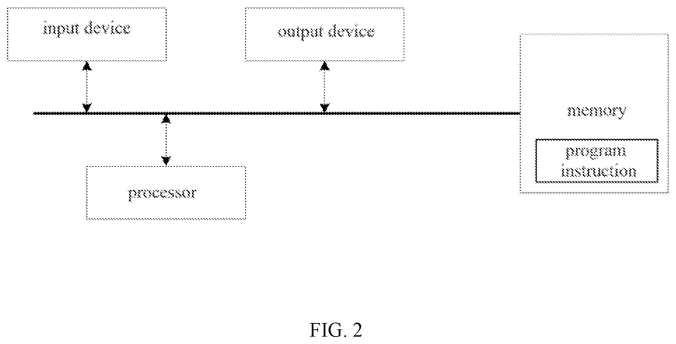

Please refer to FIG. 2, in an optional embodiment, in order to efficiently execute the method for converting tropical cyclone intensity at different time intervals provided by the present disclosure, the present disclosure also provides a system for converting tropical cyclone intensity at different time intervals. The system for converting tropical cyclone intensity at different time intervals includes a processor, an input device, an output device, and a memory. The processor, the input device, the output device, and the memory are interconnected, wherein the memory is used to store a computer program, the computer program includes program instructions, and the processor is configured to invoke the program instructions to execute the specific steps of the tropical cyclone intensity conversion method of different time intervals and embodiments relating to coefficients provided by the present disclosure. The present disclosure relates to a method and system for converting tropical cyclone intensity at different time intervals with a complete, stable and objective structure, which compensates for the shortcomings of existing time interval methods and practical application deficiency, obtains conversion methods for tropical cyclone intensity at different time intervals, improves the accuracy of intensity conversion results, enhances the comparability of tropical cyclone intensity data in China with other international tropical cyclone intensity data, and promotes the overall applicability and practical application ability of the present disclosure.

Finally, it should be noted that the above embodiments are only used to illustrate the technical solution of the present disclosure, and not intend to limit it. Although the present disclosure has been described in detail with reference to the aforementioned embodiments, those skilled in the art should understand that they can still modify the technical solutions recorded in the aforementioned embodiments, or equivalently replace some or all of the technical features thereof, and these modifications or replacements do not make the essence of the corresponding technical solutions depart from the scope of the technical solutions of the various embodiments of the present disclosure, and they should all be covered within the scope of the claims and specifications of the present disclosure.

What is claimed is:

1. A method for converting tropical cyclone intensity at different time intervals, comprising following steps:
retrieving intensity data and path information of a tropical cyclone to be determined from a typhoon operational center through data calling;
determining an average time interval of the tropical cyclone to be determined under average wind speed based on the intensity data of the tropical cyclone;
using the path information to determine a type of the tropical cyclone to be determined;
if the tropical cyclone to be determined is a tropical cyclone over ocean, then determining a current intensity index corresponding to the tropical cyclone over ocean at a specific time interval based on a cloud pattern of the tropical cyclone on satellite cloud images;
obtaining average maximum wind speed of the tropical cyclone over ocean at the specific time interval based on the current intensity index;
the step of determining a current intensity index corresponding to the tropical cyclone over ocean at a specific time interval comprises the following steps:
performing linearly interpolating on the average wind speed and the current intensity index separately based on the current intensity index of the tropical cyclone to be determined;
determining the current intensity index corresponding to the tropical cyclone over ocean at the specific time interval, wherein the step of determining the current intensity index corresponding to the tropical cyclone over ocean at the specific time interval comprises the following steps: according to a conversion coefficient table between the current intensity index of the tropical cyclone to be determined and the tropical cyclone intensity at different time intervals; determining the current intensity index corresponding to the tropical cyclone over ocean at a specific time interval;
a calculation method of the current intensity index is as follows:
$$CI = \frac{{CI}_{2} - {CI}_{1}}{{V}_{2} - {V}_{1}} \times ( V - {V}_{1} ) + {CI}_{1}$$
wherein, CI denotes the current intensity index corresponding to the tropical cyclone to be determined at the specific time interval, CI₂ denotes the current intensity index corresponding to V₂, CI₁ denotes the current intensity index corresponding to V₁, V₂ denotes the average wind speed value greater than and closest to the average wind speed value of the tropical cyclone to be determined, V₁ denotes the average wind speed value less than and closest to the average wind speed value of the tropical cyclone to be determined, and V denotes the average wind speed value of the tropical cyclone to be determined;
if the tropical cyclone to be determined is a tropical cyclone over land, determining a conversion coefficient of the tropical cyclone over land;
determining a conversion index corresponding to the tropical cyclone over land at a specific time interval based on the average time interval, the conversion coefficient, and the intensity data; wherein the step of determining a conversion index corresponding to the tropical cyclone over land at a specific time interval comprises the following steps: determining the closest distance between a center of the tropical cyclone over land and the coastline; matching the conversion coefficient of observed wind speed between different time intervals based on the closest distance; determining the conversion index corresponding to the tropical cyclone over land at a specific time interval through the conversion coefficient;
obtaining an average maximum wind speed of the tropical cyclone over land at the specific time interval through the conversion index.

2. (canceled)

3. The method for converting tropical cyclone intensity at different time intervals according to claim 1, wherein the step of using the path information to determine a type of the tropical cyclone to be determined comprises the following steps:
determining a center position of the tropical cyclone based on the path information of the tropical cyclone to be determined;
if the center position is on ocean, then the tropical cyclone to be determined is a tropical cyclone over ocean;
if the center position is on land, then the tropical cyclone to be determined is a tropical cyclone over land.

4. The method for converting tropical cyclone intensity at different time intervals according to claim 1, further comprising:
introducing a benchmark value, and the benchmark value is the current intensity index of the tropical cyclone.

5. The method for converting tropical cyclone intensity at different time intervals according to claim 1, further comprising:
setting a specific time interval between 1 and 10 minutes for converting the current intensity index between different average time intervals.

6. (canceled)

7. The method for converting the intensity of tropical cyclones at different time intervals according to claim 1, wherein the step of obtaining average maximum wind speed of the tropical cyclone over ocean at the specific time interval based on the current intensity index, the average maximum wind speed of the tropical cyclone over ocean at the specific time interval is calculated by the following formula:
$${V}_{specific time interval} = \frac{{V}_{22} - {V}_{11}}{{CI}_{2} - {CI}_{1}} \times ( CI - {CI}_{1} ) + {V}_{11}$$
wherein, V_{specific time interval} denotes the average maximum wind speed at the specific time interval, V₂₂ denotes the corresponding average wind speed value of CI₂ at a specific time interval, V₁₁ denotes the corresponding average wind speed value of CI₁ at a specific time interval, CI₂ denotes the current intensity index corresponding to V₂, CI₁ denotes the current intensity index corresponding to V₁, and CI denotes the current intensity index of the tropical cyclone over ocean at a specific time interval.

8. (canceled)

9. A system for converting tropical cyclone intensity at different time intervals, comprising a processor, an input device, an output device, and a memory, wherein the processor, the input device, the output device, and the memory are interconnected; the memory is configured to store a computer program; the computer program comprises program instructions; and the processor is configured to invoke the program instructions to execute the method for converting tropical cyclone intensity at different time intervals according to claim 1.
